(19) United States
(12) Patent Application Publication
(10) Pub. No.: US 2006/0232024 A1
(43) Pub. Date: Oct. 19, 2006

(54) Quick installment and removal tool anvil and adaptor

(76) Inventor: Chih-Yaung Chu, Taichung (TW)

Correspondence Address: CHIH-YAUNG CHU, 12, Gong 32nd Road, Taichung Industrial Park, Taichung, 407, TW

(21) Appl. No.: 11/098,696

(22) Filed: Apr. 5, 2005

(51) Int. Cl. B23B 31/12

(52) U.S. Cl. 279/79

(57) ABSTRACT

A quick installment and removal tool anvil and adaptor: The anvil is extruded from the tool body of air/electric tool, the circumferential wall of the anvil is extended to the free end of the connection flat, and the circumference of anvil in the connection flat is equipped with the vertically concave dented groove. The adaptor comprises one shaft rod, two insert pins—threaded through the shaft rod, one spring—placed on the shaft rod, one washer—placed between the spring and insert pin, one cylinder body—contained shaft rod, spring, washer and insert pins, and one collar—for stopping the shaft rod from slipping off. It's understood that this invention will enable the operator to change the adaptors in accordance with the working requirements. In other words, one tool body of air/electric tool in conjunction with the adaptors of different functions will receive multi-functions without the spending of buying different tools.

### BACKGROUND OF THE INVENTION

This invention relates to the technical field of portable air/electric tools indicating a quick installment and removal tool anvil and adaptor.

The average air/electric tools are powered by high pressure air or electricity to let the inside rotor rotate so as to drive the anvil fast and run the tools installed to the anvil, such as sockets, sanding pad, and drill bit.

Though the present air/electric tools are equipped with the anvils of different shapes, the function of which is just limited to one only.

For examples, the front end of anvil for those air/electric tools connected with the socket to fasten or remove the bolts or nuts is square and provides the single function.

And, the front end of anvil for those air/electric tools for sanding is concave with hole-bolt and delivers a single function, too.

As such, the operator has to buy different air/electric tools for different functions, and that is much money consuming at last.

In case of an apparatus being able to be quickly adapted to the air/electric tool for multi-functions, that design must be what the operators want.

### SUMMARY OF THE INVENTION

This invention is purported to provide a quick installment and removal tool anvil and adaptor to the operators for the improvement of air/electric tool limited to its single function.

The Anvil is designed with the local extrusion from the body of air/electric tool and the surface of anvil is possessed with the connection flat extended to the free end with the vertically concave dented groove; and the adaptor consists of one shaft rod, two insert pins, one spring, one washer, one cylinder body and one collar.

In order to let this invention be changed quickly and bear the high torque, the mechanism is involved with a mixture of hammer driving and connection force.

In other words, this invention is simultaneously mixed the mechanism of quick adaptor and the hammer mechanism of air/electric tool.

For arriving at the goal, the square anvil of traditional air/electric tool has been changed to an oval like double round and double flat one, while the double round is used for the connection and the double flat for the hammer driving.

Additionally, the length of double flat is extended to disperse the hammer force for bearing the high torque.

By means of the above-mentioned technical structure, this invention helps the operator change the adaptor for the air/electric tool possessed with the tool head depending on the working requirements.

That is, one air/electric tool can cover multi-functions by the change of different adaptors only for saving money buying different tools for different uses.

### BRIEF DESCRIPTION OF THE DRAWINGS

FIG. 1: Schematic plain view drawing of tool body and various adaptors,

FIG. 2: Schematic elevation drawing of adaptor,

FIG. 3: Plain view assembly drawing of adaptor in cutaway schematic illustration,

FIG. 4: Plain view and cutaway view drawing of adaptor and anvil ready to be assembled,

FIG. 5: Plain view and cutaway view drawing of adaptor and anvil in the assembly process,

FIG. 6: Plain view and cutaway view drawing of adaptor and anvil in the completed assembly.

### DETAILED DESCRIPTION OF THE PREFERRED EMBODIMENT

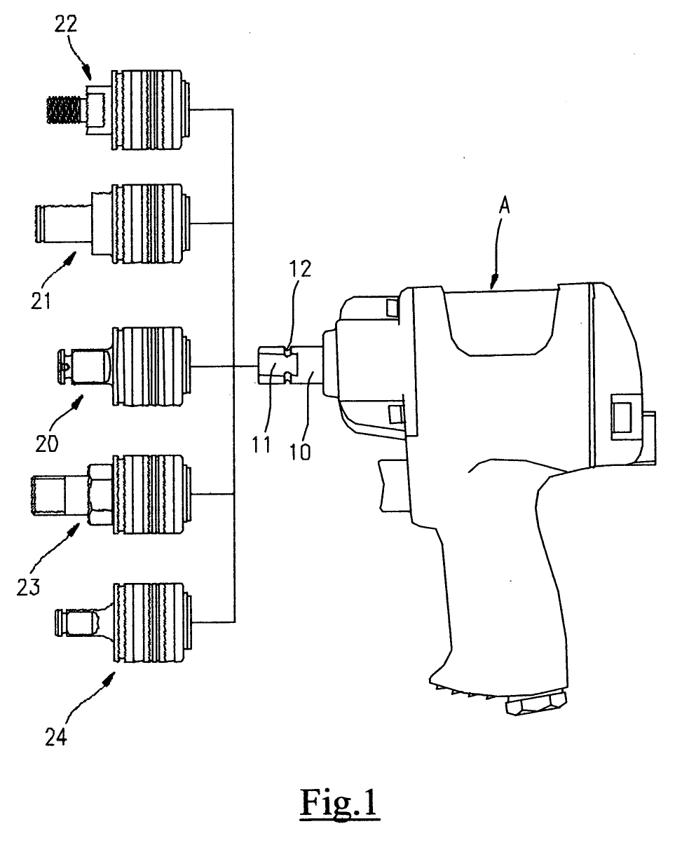

With reference to FIG. 1, the invention of quick installment and removal tool anvil and adaptor is designed to have the extruded part of anvil (10) connected with the tool body (A) of air/electric tool.

The anvil (10) has the connection flat (11) extended to the free end and it (10) also has the dented groove (12) in the circumference, which is concave with the arc shape.

In view of FIG. 1, the anvil (10) is free to connect with different adaptors (20)˜(24), i.e. the use of different adaptors (20)˜(24) to connect with different tool heads (31) will yield different functions.

The adaptor (20) as indicated in the drawing is used for impact wrench, the adaptor (21) for screwdriver, the adaptor (22) for drill, the adaptor (23) for sander, and the adaptor (24) for impact wrench.

The adaptors (20)˜(24) are different in the tool heads (31) only, while the ends connected with the anvils (10) are the same one another.

For the convenience of illustration, the adaptor (20) for impact wrench is exampled for the description.

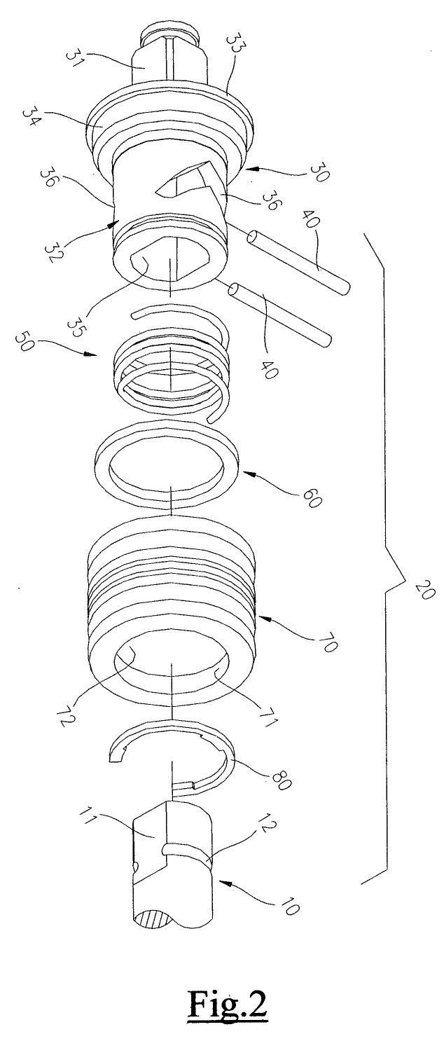

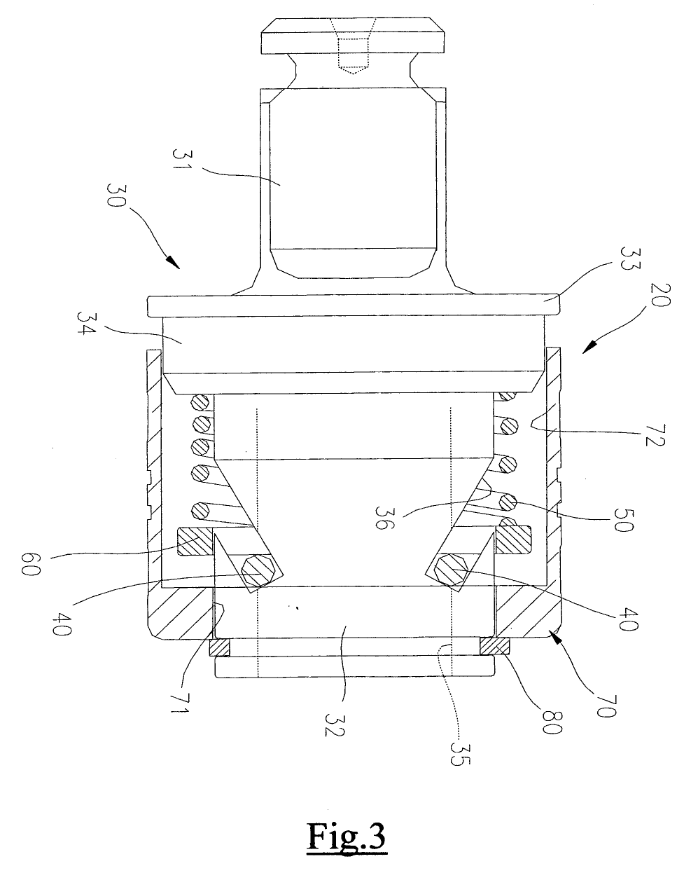

The adaptor (20) as illustrated in FIG. 2 and FIG. 3 comprises one shaft rod (30), two insert pins (40)—threaded through the shaft rod (30), one spring (50)—placed on the shaft rod (30), one washer (60)—placed between the spring (50) and insert pin (40), one cylinder body (70)—contained shaft rod (30), spring (50), washer (60) and insert pins (40), and one collar (80)—for stopping the shaft rod (30) from slipping off.

One end of shaft rod (30) is inserted to the shaft rod base (32) inside the cylinder body (70) and another end is extruded from the cylinder body (70) to be the tool head (31).

The shape of tool head (31) will be different depending on the functions to be applied.

The end of shaft rod base (32) close to the tool head (31) is possessed with the stopper face (33) of bigger external dimension and the sleeve connection (34) between stopper face (33) and shaft rod base (32), and the center end of shaft rod base (32) has the sleeve hole (35) with the flat surface inside and the circumferential wall of shaft rod base (32) has the cutting groove (36) which is extended to the free end of shaft rod base (32) through the sleeve hole (35) for insert pin (40) to thread through and position in the cutting groove (36).

Both ends of insert pins (40) are extruded a little bit on the circumferential wall of shaft rod base (32) for letting the spring (50) on the shaft rod base (32) and washer (60) be compressed and stopped between the insert pin (40) and the sleeve connection (34), and the insert pin (40) affected by the power of spring (50) is, therefore, pushed to the bottom of cutting groove (36) by way of the washer (60).

The bottom of cutting groove (36) and the sleeve hole (35) of shaft rod base (32) are freely passed, so that the insert pin (40) would go through and stay in the sleeve hole (35) when it is placed in the bottom of cutting groove (36).

The cylinder body (70) is equipped with the first sleeve hole (71) and the second sleeve hole (72) inside the same shaft to be trapped separately with shaft rod base (32) of shaft rod (30) and the circumferential wall of sleeve connection (34).

The shaft rod base (32) extruded from the cylinder body (70) is fixed by the collar (80) so that the internal and external circumferential wall of the first sleeve hole (71) affected by the power of spring (50) will stay between the insert pin (40) and the collar (80); and the end of the second sleeve hole (72) is reserved a space with the stopper face (33) of the shaft rod (30).

The above-mentioned description is the introduction of the composing parts of the invented adaptor (20).

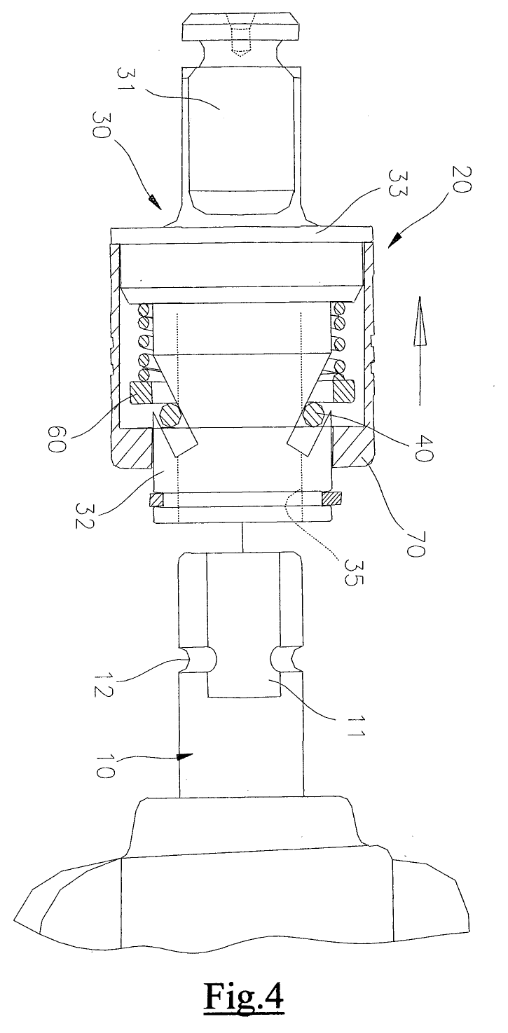

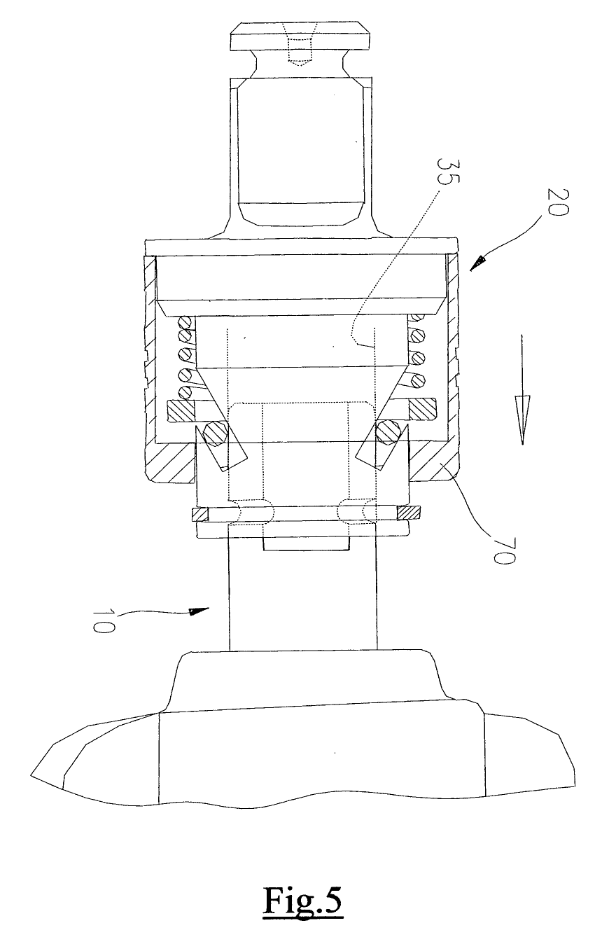

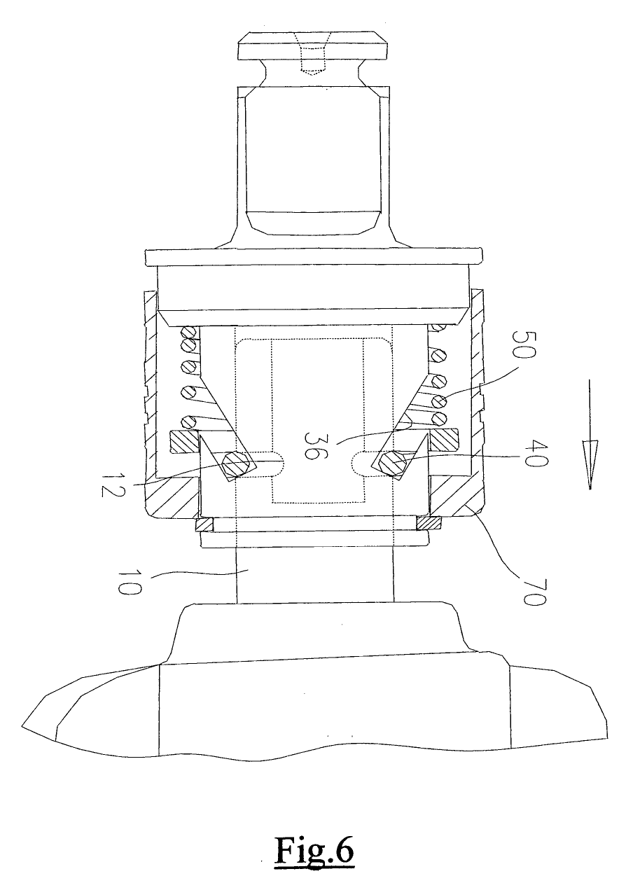

When connecting the adaptor (20) with the anvil (10) of air/electric tool, push the cylinder body (70) as indicated in FIG. 4 to the stopper face (33) of the shaft rod (30) and push the insert pin (40) out to the bottom of the cutting groove (36) to let the insert pin (40) leave the sleeve hole (35) of the shaft rod (30), and place the adaptor (20) as shown in FIG. 5 by inserting the sleeve hole (35) of the shaft rod (30) to the anvil (10), and when the dented groove (12) of anvil (10), as shown in FIG. 6, is positioned in the bottom of cutting groove (36), the insert pin (40) simultaneously pushed by the power of spring (50) is reached to the bottom of cutting groove (36) and blocked in the dented groove (12) of the anvil (10) for avoiding the adaptor (20) slipping off.

In the meantime, FIG. 2 shows that the anvil (10) and the sleeve hole (35) of the shaft rod (30) are connected through the connection flat (11) with a non-round connection, so that the mutual driving is not possible; but the anvil (10) will drive the adaptor (20) to have the rotation work.

When changing the different adaptor, just push the cylinder body (70) of the adaptor (20) to the stopper face (33) of the shaft rod (30) and let the insert pin (40) loosen from the dented groove (12) of the anvil (10), then the anvil (10) will be removed.

It's understood that this invention will enable the operator to change the adaptors in accordance with the working requirements.

In other words, one tool body of air/electric tool in conjunction with the adaptors of different functions will receive multi-functions without the spending of buying different tools.

1. A quick installment and removal tool anvil is extruded from the tool body of air/electric tool, the circumferential wall of the anvil is extended to the free end of the connection flat, and the circumference of anvil in the connection flat is equipped with the vertically concave dented groove.

2. The first item of the patent application is the quick installment and removal tool anvil, of which the dented groove is presented to be the ring shape on the anvil.

3. A quick installment and removal tool adaptor is composed of
1) Shaft rod: The both ends of shaft rod are the shaft rod base, tool head, stopper face—located in the end of shaft rod near the tool head, sleeve connection—between the stopper face and the shaft rod base, sleeve hole—the center end of shaft rod base has the axial concavity combined with the anvil of tool body to be a non-round shape, cutting groove—on the circumferential wall of shaft rod base with the inclined extension to the free end of shaft rod base, the bottom of cutting groove has the passage with the sleeve hole, the insert pin is vertically inserted to the cutting groove, and the both ends of insert pin are extruded over the circumferential wall of shaft rod base.
2) Spring: on the shaft rod base of shaft rod to be pushed to the space between insert pin and the end of sleeve connection by the compression of washer.
3) Washer: placed between the spring and the insert pin.
4) Cylinder body: same axis inside the cylinder and separately wrapping the shaft rod base of shaft rod, the first sleeve hole of sleeve connection, and the second sleeve hole. The shaft rod base is extruded over the end of the first sleeve hole of the cylinder body and fastened by the collar. The first sleeve hole is positioned between the insert pin and the collar. Normally, the end of the second sleeve hole and the stopper face of the shaft rod are reserved with a space.

4. A quick installment and removal tool anvil and adaptor:
The anvil is extruded from the tool body of air/electric tool, the circumferential wall of the anvil is extended to the free end of connection flat, and the circumference of anvil in the connection flat is equipped with the vertically concave dented groove.
The adaptor comprising:
1) Shaft rod: The both ends of shaft rod are the shaft rod base, tool head, stopper face—located in the end of shaft rod near the tool head, sleeve connection—between the stopper face and the shaft rod base, sleeve hole—the center end of shaft rod base has the axial concavity combined with the anvil of tool body to be a non-round shape, cutting groove—on the circumferential wall of shaft rod base with the inclined extension to the free end of shaft rod base, the bottom of cutting groove has the passage with the sleeve hole, the insert pin is vertically inserted to the cutting groove, and the both ends of insert pin are extruded over the circumferential wall of shaft rod base.
2) Spring: on the shaft rod base of shaft rod to be pushed to the space between insert pin and the end of sleeve connection by the compression of washer.
3) Washer: placed between the spring and the insert pin.
4) Cylinder body: same axis inside the cylinder and separately wrapping the shaft rod base of shaft rod, the first sleeve hole of sleeve connection, and the second sleeve hole. The shaft rod base is extruded over the end of the first sleeve hole of the cylinder body and fastened by the collar. The first sleeve hole is positioned between the insert pin and the collar. Normally, the end of the second sleeve hole and the stopper face of the shaft rod are reserved with a space.
